(19) United States
(12) Patent Application Publication
(10) Pub. No.: US 2023/0028979 A1
(43) Pub. Date: Jan. 26, 2023

(54) METHOD FOR DISPLAYING IMAGE, ELECTRONIC DEVICE AND COMPUTER READABLE MEDIUM

(71) Applicant: SCHNEIDER ELECTRIC INDUSTRIES SAS, Rueil Malmaison (FR)

(72) Inventors: Weihe FEI, Shanghai (CN); Minghong LU, Shanghai (CN); Jianwei TIAN, Shanghai (CN); Xiaolong ZHU, Shanghai (CN)

(73) Assignee: SCHNEIDER ELECTRIC INDUSTRIES SAS, Rueil Malmaison (FR)

(21) Appl. No.: 17/788,947

(22) PCT Filed: Dec. 24, 2020
(86) PCT No.: PCT/CN2020/139088

§ 371 Date: Jun. 24, 2022

(30) Foreign Application Priority Data
Dec. 25, 2019 (CN) 201911357922.7

(51) Int. Cl. G09G 3/20

(52) U.S. Cl. CPC G09G 3/2003; G09G 2320/0666; G09G 2320/0606

(57) ABSTRACT

A method for displaying an image, an electronic device and a computer readable medium. The method for displaying an image includes: on the basis of the number of color bits of the image to be displayed, determining at least one image color data item associated with the image; determining at least one device color data item corresponding to the at least one image color data item, the length of the device color data item matching the number of color bits of a display device; and replacing the at least one image color data item with the at least one device color data item so as to display the image on the display device. The method for displaying an image can reduce the impact on the consumption of system memory resources due to the use of a high-capacity and high-resolution display.

### FIELD

Embodiments of the present disclosure relate to image display, and more particularly to a method, electronic device and computer readable medium for displaying an image.

### BACKGROUND

A display is a main component of human-machine interface products for industrial control. In order to improve the user experience of human-machine interface products, more and more industrial human-machine interface products tend to use displays with rich colors, delicate images and wide viewing angles, such as color high-resolution thin-film Field-Effect Transistor (TFT) liquid crystal displays, which also means that thoughts are given to increasing a number of Random Access Memories (RAMs) with a larger capacity upon system design to buffer the content of images to be displayed, to facilitate editing and modifying the human-machine interface images. For example, for an embedded system commonly used in industrial products, memory resources are usually limited. Only 1K of RAM display memory is needed to drive a monochrome display with a 128*64 resolution, whereas 225K of RAM display memory is needed to drive a 24-bit RGB TFT display with a 320*240 resolution, which greatly increases the cost of the hardware system.

### SUMMARY

Embodiments of the present disclosure provide a method, electronic device, and computer-readable medium for displaying an image.

At a first aspect of the present disclosure, there is provided a method for displaying an image. The method comprises: determining at least one image color data item associated with an image to be displayed, based on a number of color bits of the image to be displayed; determining at least one device color data item corresponding to the at least one image color data item, a length of the device color data item matching the number of color bits of the display device; and replacing the at least one image color data item with the at least one device color data item to display the image to be displayed on the display device.

At a second aspect of the present disclosure, there is provided an electronic device. The electronic device comprises: determining at least one image color data item associated with an image to be displayed, based on the number of color bits of the image to be displayed; determining at least one device color data item corresponding to the at least one image color data item, a length of the device color data item matching the number of color bits of the display device; and replacing the at least one image color data item with the at least one device color data item to display the image to be displayed on the display device.

At a third aspect of the present disclosure, there is provided a computer-readable storage medium including a computer program stored thereon, wherein the program, when being executed by a processer, performs the method according to the first aspect of the present disclosure.

It should be appreciated that this Summary is not intended to identify key features or essential features of the claimed subject matter, nor is it intended to be used to limit the scope of the claimed subject matter. Other features of the present disclosure will become apparent through the following depictions.

### BRIEF DESCRIPTION OF THE DRAWINGS

The above and other objects, features and advantages of embodiments of the present disclosure will become more apparent through the following detailed description with reference to the accompanying drawings. In the drawings, a plurality of embodiments of the present disclosure will be illustrated in an exemplary but unrestrictive way. In the drawings:

FIG. 1 illustrates a schematic diagram of an example environment 100 for displaying images according to some embodiments of the present disclosure;

FIG. 2 illustrates a flowchart of a method 200 for displaying images according to some embodiments of the present disclosure;

FIG. 3 illustrates a schematic diagram of a mapping relationship 300 between image color data items and device color data items according to some embodiments of the present disclosure; and

FIG. 4 illustrates a schematic block diagram of a device 400 that may be used to implement embodiments of the present disclosure.

### DETAILED DESCRIPTION OF EMBODIMENTS

The concept of the present disclosure will now be described with reference to various exemplary embodiments shown in the drawings. It should be appreciated that these embodiments are described only to enable those skilled in the art to better understand and further implement the present disclosure, and are not intended to limit the scope of the present disclosure in any way. It should be appreciated that in feasible cases, similar or identical reference numbers may be used in the drawings, and similar or identical reference numbers may denote similar or identical elements. Those skilled in the art will appreciate, from the following descriptions, that alternative embodiments of the structures and/or methods described herein may be employed without departing from the described principles and concepts of the present disclosure.

In the context of the present disclosure, the term “comprise” and its various variants may be understood as open-ended terms meaning “comprise but not limited to”; the term “based on” may be understood as “at least in part based on”; the term “one embodiment” may be understood as “at least one embodiment”; the term “another embodiment” may be understood as “at least one other embodiment”. Other terms that might appear but are not mentioned here, unless explicitly stated, should not be interpreted or defined in a way that is contrary to the concept on which the embodiments of the present disclosure are based.

As stated above, in order to improve the user experience of human-machine interface products, more and more industrial human-machine interface products tend to use displays with rich colors, delicate images and wide viewing angles, such as color high-resolution thin-film Field-Effect Transistor (TFT) liquid crystal displays, which also means that a Random Access Memory (RAM) with more capacity needs to be increased upon system design to buffer the content of images to be displayed, to facilitate editing and modifying the human-machine interface images. For example, for an embedded system commonly used in industrial products, memory resources are usually limited. Only 1K of RAM display memory is needed to drive a monochrome display with a 128*64 resolution, whereas 225K of RAM display memory is needed to drive a 24-bit RGB TFT display with a 320*240 resolution, which greatly increases the cost of the hardware system.

In order to solve the above problems and/or other potential problems, embodiments of the present disclosure propose a solution for displaying an image. The solution can determine at least one image color data item associated with the image to be displayed, based on a number of color bits of the image to be displayed. The solution can determine at least one device color data item corresponding to the at least one image color data item, a length of the device color data item matching the number of color bits of the display device. The solution can replace the at least one image color data item with the at least one device color data item to display the image to be displayed on the display device. In this way, the solution can reduce the impact on the consumption of memory resources of the system due to the use of a large-capacity and high-resolution display.

The basic principles and implementations of the present disclosure are described below with reference to the drawings. It should be appreciated that the exemplary embodiments are given only to enable those skilled in the art to better understand and implement the embodiments of the present disclosure, but not to limit the scope of the present disclosure in any way.

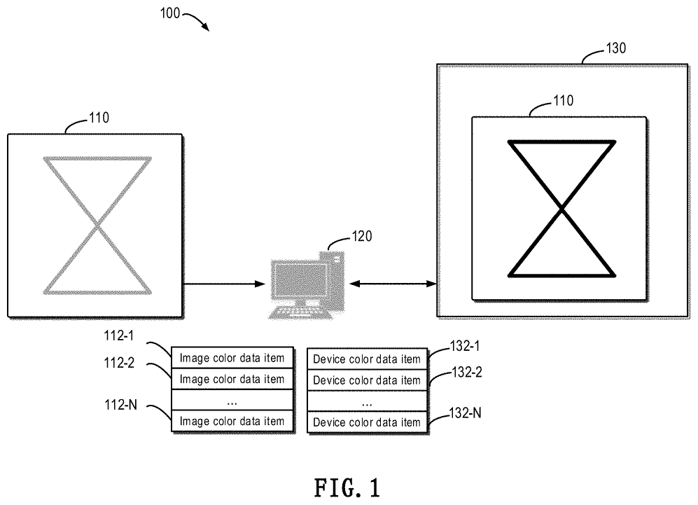

FIG. 1 illustrates a schematic diagram of an example environment 100 for displaying an image according to some embodiments of the present disclosure. As shown in FIG. 1, the environment 100 includes an electronic device 120. The electronic device 120 may be an embedded system, a computer, a server, or any other device that may be used to display the image. Although one electronic device 120 is shown in FIG. 1, it should be appreciated that this is only for purpose of illustration, and is not intended to limit the scope of the present disclosure. In some embodiments, other devices of different numbers and/or with different functions may also be included.

As shown in FIG. 1, the electronic device 120 may process an image to be displayed 110 to display the image to be displayed 110 in the display device 130. Although one image to be displayed 110 is shown in FIG. 1, it should be appreciated that this is only for an illustration purpose and is not intended to limit the scope of the present disclosure. In some embodiments, other images to-be-displayed of different numbers and/or with different contents may also be included.

The electronic device 120 may determine the total number M of colors used in the image to be displayed 110, where M is a positive integer greater than 1. Based on the total number M of colors, the electronic device 120 may determine the number of color bits of the image to be displayed 110. The electronic device 120 may determine one or more image color data items 112-1, 112-2, . . . , 112-N based on the number of color bits of the image to be displayed, where N is a positive integer greater than 1. The length of each image color data item may be equal and matches the number of color bits of the image to be displayed.

For example, if 16 colors are used in the image to be displayed 110, since 16 different numbers (e.g., 0, 1, 2, . . . , 15) can be represented by a 4-bit binary number (e.g., 0000, 0001, 0010, . . . , 1111), it can be determined that the number of color bits of the image to be displayed 110 is 4. The electronic device 120 may determine that the image color data items are 0000, 0001, 0010, . . . , 1111, respectively, based on the length of the color bits number of the image to be displayed being 4.

It should be appreciated that the image color data items 112-1, 112-2, . . . , 112-N may be data items of any suitable length, for example, if the length of the data items representing colors supported by the image to be displayed is 4 bits, then the image color data items 112-1, 112-2, . . . , 112-N are 4-bit binary numbers and the like.

The electronic device 120 may determine one or more device color data items 132-1, 132-2, . . . , 132-N corresponding to one or more image color image items 112-1, 112-2, . . . , 112-N, where N is a positive integer greater than 1. The length of the device color data items 132-1, 132-2, . . . , 132-N matches the number of color bits of the display device 130. The length of each device color data item may be equal and matches the number of color bits of the display device 130.

It should be appreciated that the device color data items 132-1, 132-2, . . . , 132-N may be data items of any suitable length, for example, if the display device 130 is capable of displaying 2²⁴ colors, the device color data items 132-1, 132-2, . . . , 132-N are 24-bit binary numbers and the like. It should also be appreciated that the display device 130 may be any device capable of displaying images, e.g., a display device of a human-machine interface for industrial control, e.g., a light emitting diode (LED) display, a liquid crystal (LCD) display and the like.

The electronic device 120 may replace the image color data items 112-1, 112-2, . . . , 132-N having a smaller length with the device color data items 132-1, 132-2, . . . , 132-N having a larger length. Since the device color data items 132-1, 132-2, . . . , 132-N match the display device 130, the image to be displayed 110 with richer colors may be displayed in the display device 130.

The electronic device 120 may also include a processor and a memory. In some embodiments, the memory may store computer programs whose instructions may be executed by a processor to control operations of the electronic device. It should be appreciated that the electronic device 120 may also include some other modules and/or devices not shown in FIG. 1, such as a communication module, an input and output device, and so on.

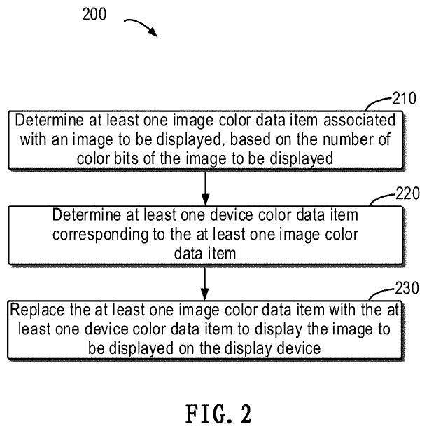

FIG. 2 illustrates a flowchart of a method 200 for displaying an image according to some embodiments of the present disclosure. It should be appreciated that at least a portion of the method 200 may be performed by the electronic device 120 described above with reference to FIG. 1. The method 200 may also include blocks not shown and/or omit blocks as shown. The scope of the present disclosure is not limited in this regard.

At block 210, the electronic device 120 may determine one or more image color data items 112-1, 112-2, . . . , 112-N associated with the image to be displayed 110, based on the number of color bits of the image to be displayed 110. In some embodiments, the number of color bits of the image to be displayed 110 may be any suitable preset number of bits. For example, the number of the color bits of the image to be displayed 110 may be preset to be 2, and then the image color data items may be 00, 01, 10, and 11, respectively. That is, the image to be displayed 110 may display an image with 4 colors. In this way, the colors in the image to be displayed 110 may be represented by a data item with a smaller length, thereby reducing the occupation of the memory.

Alternatively, in other embodiments, the number of color bits of the image to be displayed 110 is determined based on the total number of colors in the image to be displayed 110. For example, there are a total of 16 colors in one or more images to-be-displayed 110 displayed on the display device 130. Since 4-bit binary numbers (e.g., 0000, 0001, 0010, . . . , 1111) may represent 16 different numbers (for example, 0, 1, 2, . . . , 15), it may be determined that the number of color digits of the image to be displayed 110 is 4. The electronic device 120 may determine that the image color data items are 0000, 0001, 0010, 1111, respectively, based on the length of color bits number of the image to be displayed being 4. In this way, the colors in one or more images to-be-displayed 110 are represented by binary data items with a minimum number of bits, which may minimize the memory occupied by the system upon processing the images.

At block 220, the electronic device 120 may determine one or more device color data items 132-1, 132-2, . . . , 132-N corresponding to one or more image color data items 112-1, 112-2, . . . , 112-N. In some embodiments, the length of one or more device color data items 132-1, 132-2, . . . , 132-N matches the number of color bits of the display device 130. For example, if the display device 130 is a 24-bit display device, that is, it may display 2²⁴ different colors, these 2²⁴ different colors may be represented by 2²⁴ binary numbers with a length 24, that is, the length of the device color data items 132-1, 132-2, . . . , 132-N is 24 (e.g., 00000000 11001001 11111000). In this way, the display device 130 may display the images to be displayed in richer colors.

In some embodiments, the electronic device 120 may determine a set of device color data items of the display device 130. Still taking the 24-bit display device 130 as an example, the electronic device 120 may determine a set of color data items including 2²⁴ data items, each data item being represented by a binary data item with a length 24 and corresponding to one color. The electronic device 120 may select one or more device color data items 132-1, 132-2, . . . , 132-N from the set of device color data items for display. In this manner, the electronic device 120 may determine a color matching the display device 130 to facilitate displaying.

In some embodiments, the number of device color data items and the number of image color data items may be equal so as to facilitate retaining the color contrast and distinction of the images to be displayed 110. Alternatively, in other embodiments, the number of device color data items and the number of image color data items may be different, so as to modify and update the images to be displayed 110 according to actual requirements. In this way, the electronic device 120 may flexibly control the colors of the images to be displayed 110.

In some embodiments, the electronic device 120 may randomly select one or more device color data items 132-1, 132-2, . . . , 132-N from the set of device color data items. In other embodiments, the electronic device 120 may select one or more device color data items 132-1, 132-2, . . . , 132-N from the set of device color data items in a predetermined order. In yet other embodiments, electronic device 120 may select one or more device color data items 132-1, 132-2, . . . , 132-N from the set of device color data items based on a preference input by the user. For example, the user may select one or more colors of the image to be displayed 110 according to an overall color collocation of the image to be displayed 110 or a preference for a certain color. The electronic device 120 may select one or more device color data items 132-1, 132-2, . . . , 132-N from the set of device color data items based on user's selection of the color. In this manner, electronic device 120 may determine the color adapted to be displayed in the display device 130.

At block 230, electronic device 120 may replace one or more image color data items 112-1, 112-2, . . . , 112-N with one or more device color data items 132-1, 132-2, . . . , 132-N to display the image to be displayed 110 on the display device 130. In some embodiments, the electronic device 120 may replace all image color data items with corresponding color data items, and then send the image to be displayed 110 to the display device 130, so that the display device 130 may completely display the image to be displayed 110 at one time. In this way, the electronic device 120 only needs to process the image color data items with a smaller length during image processing, and turn to device color data items with a larger length only when the images are to be displayed, thereby substantially reducing the memory resources occupied by the display of the images.

Alternatively, in order to further reduce the occupation of the memory, the electronic device 120 may divide the image to be displayed 110 into a plurality of image blocks, and then first replace the image color data item of the first image block in the plurality of image blocks with a corresponding device color data item. After completion of the replacement, the electronic device 120 sends the first image block to the display device 130 to display the first image block. Meanwhile, the electronic device 120 continues to replace the image color data item in the second image block, and upon completion of the replacement, sends the second image block to the display device 130 to display the second image block. By such analogy, all image blocks will be sent to the display device 130 in batches sequentially, so that the whole image to be displayed 110 is displayed in the display device 130. In this way, since the image color data items associated with the image to be displayed 110 are replaced in batches sequentially, the memory needed for displaying the image may be further reduced.

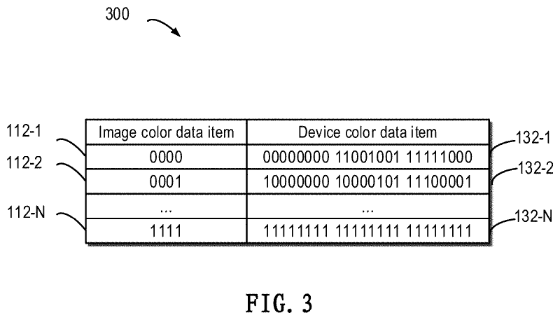

In some embodiments, electronic device 120 may establish a mapping relationship 300 between one or more device color data items 132-1, 132-2, . . . , 132-N and one or more image color data items 112-1, 112-2, . . . , 112-N. For example, FIG. 3 illustrates a schematic diagram of the mapping relationship 300 between image color data items and device color data items according to some embodiments of the present disclosure. In the example of FIG. 3, one or more device color data items 132-1, 132-2, . . . , 132-N and corresponding one or more image color data items 112-1, 112-2, . . . , 112-N are shown in tabular form, and each image color data item in the table is replaced by a device color data item in the same row. In this way, according to the mapping relationship 300, the user may accurately know the corresponding relationship between the current image color data item and the device color data item, so as to facilitate the user to perform subsequent operations.

In some embodiments, the electronic device 120 may update the mapping relationship 300 in response to the user's adjustment to the mapping relationship 300. For example, the user may adjust one or more colors to be displayed on the display device 130 according to the overall color collocation of the image or personal preference. If the user wants to change an area that was originally displayed in pink to be displayed in amber, the electronic device 120 may replace the device color data item 132-2 (shown as “10000000 10000101 11100001” in FIG. 3) representing pink in the mapping relationship 300 with another data item (for example, “11100000 10011101 00100000”) representing amber color. The electronic device 120 may display the image to be displayed 110 based on the updated mapping relationship 300. In this way, the user may adjust the colors of the image to be displayed 110 according to actual requirements.

Although in the above description the length of the image color data items is assumed to be 4, and the length of the device color data items is assumed to be 24, it should be appreciated that any other suitable length is suitable for the present invention. For example, the length of the image color data items may also be 2, 3, 5, etc., and the length of the device color data items may also be 12, 24, etc.

In addition, although the above description only involves the case where the length of the image color data items is smaller than the length of the device color data items (i.e., the total number of colors in one or more images to-be-displayed 110 is less than the total number of colors that can be displayed by the display device 130), it should be appreciated that the length of the image color data items may also be greater than the length of the device color data items (i.e., the total number of colors in one or more images to-be-displayed 110 is greater than the total number of colors that can be displayed by the display device 130). For example, in the case where the number of color bits of the display device 130 is small (e.g., only 16 colors can be displayed), if the total number of colors in the image to be displayed 110 is 17, two image color data items 112-1 and 112-2 associated with the image to be displayed 110 may correspond to the same device color data item 132-1. In this way, the two colors in the image data to be displayed may be displayed in one color on the image display device 130, so that the image to be displayed 110 may be displayed on various different types of display devices 130 in a case where a lot of modification and maintenance are not performed on the operation process of the electronic device 120.

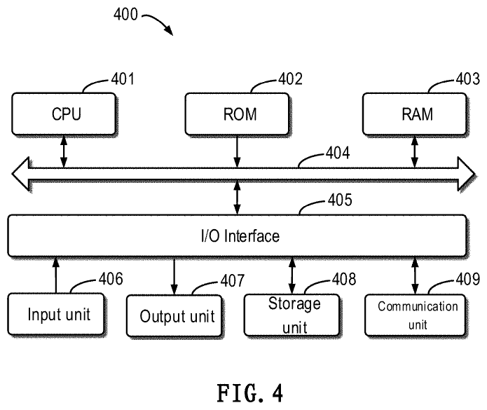

FIG. 4 illustrates a schematic block diagram of a device 400 that may be used to implement embodiments of the present disclosure. The device 400 may be the electronic device 120 described above with reference to FIG. 1. As shown in FIG. 4, the device 400 comprises a central processing unit (CPU) 401 that may perform various appropriate actions and processing based on computer program instructions stored in a read-only memory (ROM) 402 or computer program instructions loaded to a random access memory (RAM) 403 from a storage unit 408. In the RAM 403, there further store various programs and data needed for operations of the device 400. The CPU 401, ROM 402 and RAM 403 are connected to each other via a bus 404. An input/output (I/O) interface 405 is also connected to the bus 404.

Various components in the device 400 are connected to the I/O interface 405, including: an input unit 406 such as a keyboard, a mouse and the like; an output unit 407 including various kinds of displays and a loudspeaker, etc.; a storage unit 408 including a magnetic disk, an optical disk, and etc.; a communication unit 409 including a network card, a modem, and a wireless communication transceiver, etc. The communication unit 409 allows the device 400 to exchange information/data with other devices through a computer network such as the Internet and/or various kinds of telecommunications networks.

Various methods and processes described above may be executed by the CPU 401. For example, in some embodiments, the method 200 may be implemented as a computer software program that is tangibly included in a machine readable medium, e.g., the storage unit 408. In some embodiments, part or all of the computer program may be loaded and/or mounted onto the device 400 via ROM 402 and/or communication unit 409. When the computer program is loaded to the RAM 403 and executed by the CPU 401, one or more steps of the method as described above may be executed.

In some embodiments, the methods and processes described above may be implemented as a computer program product. The computer program product may include a computer readable storage medium on which computer readable program instructions for executing various aspects of the present disclosure are embodied.

The computer readable storage medium may be a tangible device that may retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

These computer readable program instructions may be provided to a processing unit of a general purpose computer, special purpose computer, or other programmable data processing apparatus to produce a machine, such that the instructions, which execute via the processor of the computer or other programmable data processing apparatus, create means for implementing the functions/actions specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/actions specified in the flowchart and/or block diagram block or blocks.

The flowchart and block diagrams in the drawings illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or actions, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for displaying an image, comprising:
determining at least one image color data item associated with an image to be displayed, based on a number of color bits of the image to be displayed;
determining at least one device color data item corresponding to the at least one image color data item, a length of the device color data item matching the number of color bits of the display device; and
replacing the at least one image color data item with the at least one device color data item to display the image to be displayed on the display device.

2. The method according to claim 1, further comprising:
determining a total number of colors in the image to be displayed;
determining the number of color bits of the image to be displayed based on the total number of colors.

3. The method according to claim 1, wherein determining the at least one device color data item comprises:
determining a set of device color data items of the display device; and
selecting the at least one device color data item from the set of device color data items, the number of the at least one device color data item being equal to the number of the at least one image color data item.

4. The method according to claim 3, wherein selecting the at least one device color data item from the set of device color data items comprises:
selecting the at least one device color data item from the set of device color data items based on a preference input by a user.

5. The method according to claim 1, wherein replacing the at least one image color data item comprises:
dividing the image to be displayed into a plurality of image blocks; and
replacing the at least one image color data item one image block after another with the at least one device color data item.

6. The method according to claim 1, wherein replacing the at least one image color data item comprises:
establishing a mapping relationship between the at least one image color data item and the at least one device color data item;
updating the mapping relationship in response to receiving an adjustment to the mapping relationship from a user; and
replacing the at least one image color data item with at least one device color data item in the updated mapping relationship.

7. The method according to claim 1, wherein a length of the at least one image color data item is smaller than that of the at least one device color data item.

8. An electronic device, comprising:
a processor; and
a memory storing computer program instructions, the processor running the computer program instructions in the memory to control the electronic device to perform actions, the actions comprising:
determining at least one image color data item associated with an image to be displayed based on a number of color bits of the image to be displayed;
determining at least one device color data item corresponding to the at least one image color data item, a length of the device color data item matching the number of color bits of the display device; and
replacing the at least one image color data item with the at least one device color data item to display the image to be displayed on the display device.

9. The electronic device according to claim 8, the actions further comprising:
determining a total number of colors in the image to be displayed;
determining the number of color bits of the image to be displayed based on the total number of colors.

10. The electronic device according to claim 8, wherein determining the at least one device color data item comprises:
determining a set of device color data items of the display device; and
selecting the at least one device color data item from the set of device color data items, the number of the at least one device color data item being equal to the number of the at least one image color data item.

11. The electronic device according to claim 10, wherein selecting the at least one device color data item from the set of device color data items comprises:
selecting the at least one device color data item from the set of device color data items based on a preference input by the user.

12. The electronic device according to claim 8, wherein replacing the at least one image color data item comprises:
dividing the image to be displayed into a plurality of image blocks; and
replacing the at least one image color data item one image block after another with the at least one device color data item.

13. The electronic device according to claim 8, wherein replacing the at least one image color data item comprises:
establishing a mapping relationship between the at least one image color data item and the at least one device color data item;
updating the mapping relationship in response to receiving an adjustment to the mapping relationship from the user; and
replacing the at least one image color data item with at least one device color data item in the updated mapping relationship.

14. The electronic device according to claim 8, wherein a length of the at least one image color data item is smaller than that of the at least one device color data item.

15. A non-transitory computer-readable storage medium including a computer program stored thereon, wherein the program, when executed by a processer, performs the method according to claim 1.
